(19) United States
(12) Patent Application Publication
(10) Pub. No.: US 2019/0106838 A1
(43) Pub. Date: Apr. 11, 2019

(54) IN HEAD FOIL APPLICATOR FOR A TEXTILE PRINTING APPARATUS

(71) Applicant: M&R Printing Equipment, Inc., Roselle, IL (US)

(72) Inventors: Richard C. Hoffman, JR., Lake Forest, IL (US); Humberto Quintero, Chicago, IL (US); Jerzy Podstawka, Arlington Heights, IL (US); Darek Tkacz, Naperville, IL (US)

(21) Appl. No.: 15/728,105

(22) Filed: Oct. 9, 2017

(51) Int. Cl. D06Q 1/12; B41F 15/08

(52) U.S. Cl. CPC D06Q 1/12; B41F 15/08

(57) ABSTRACT

The present invention provides a foil applicator assembly for a screen printing press having a support arm extending along a first line. The assembly has a carriage having a leading edge and a trailing edge and is mounted for reciprocating translational motion along the first line. A press roller is mounted to the carriage and has a first axis of rotation generally orthogonal to the first line. A film supply roller is mounted proximate the press by a member that is stationary with respect to the carriage and provides a second axis of rotation parallel to the first axis of rotation and has a first outer surface. A film guide member is mounted on the carriage and is spaced from the press roller along the first line.

### CROSS-REFERENCE TO RELATED APPLICATIONS

N/A

### FEDERALLY SPONSORED RESEARCH OR DEVELOPMENT

N/A

### FIELD OF THE INVENTION

The present invention is directed to a foil applicator for decorating textiles on a screen printing press and more particularly to a foil applicator mounted for reciprocating movement along a length of a print arm of the screen printing press.

### DESCRIPTION OF THE PRIOR ART

Screen printing is an art form that is thousands of years old and involves depositing ink on a screen with a pattern thereon and squeegeeing the ink so that it passes through the screen onto the item such as a textile to bear the pattern. Screen printing is commonly used for decorating clothing such as T-shirts, pants, and other items like hand bags and totes, with slogans, college names, sports team, trademarks and the like. The indicia can include either simple one-color block letters or elaborate multi-color illustrations.

In common use in the silk screening industry are a multi-station turret type (U.S. Patent Publication No. 2011/0290127) and oval-type (U.S. Patent Publication No. 2010/0000429) printing presses (both of these patent applications are incorporated herein by reference and made a part hereof). These printing presses have a plurality of flat beds or platens spaced along their perimeter, one for each color. The number of stations employed depends on the number of colors to be printed on the object. Indicia can consist of up to ten colors or more.

One significant challenge in screen printing is the time necessary to prepare each screen. The general process for setting-up the screens for printing follows: First, the artwork is set up. The artwork, in the form of a film positive, is secured on a layout board. Next, a carrier sheet (optically clear polyester film) is placed on the layout board. An individual separates the colors by transferring the artwork by hand to one or more carrier sheets. In this separation/transference process, each carrier sheet represents a separate color to be used in the final screened textile. Thus, if there are six colors being screened, there will be six carrier sheets (art separations) completed.

Second, the stenciled screens are made by covering the mesh of the screen with an ultraviolet sensitive emulsion. Each carrier sheet is aligned with such an emulsion covered screen and placed in a vacuum exposure unit with a UV light source such that the carrier sheet is disposed between the light source and the screen. The screen/carrier sheet combination is subjected to a vacuum, to bring them into contact with one another, and exposed to UV light. The carrier sheet prevents the underlying emulsion from curing. When the exposed screen is washed with a high pressure spray of water, the uncured portions underlying the carrier sheet wash away leaving an open mesh while the portions of the screen not covered by the carrier sheet are cured and do not wash away and leave a closed mesh.

Third, each printing screen is secured to a printing head. One color of ink is then placed into each printing head. With all of the screens mounted to a printing press, textiles are loaded, one at a time, onto the travelling pallets and the pallets travel to each of the printing stations where an ink of a single color is applied to the textile. Each printed textile is cured typically by applying heat with a dryer.

There are several types of ink that are used for textile printing including water-based inks, plastisols and sublimation inks. Water-based inks utilize either dyes or pigments in a suspension with water as the solvent. The evaporation of the water is necessary to set or cure the ink. This curing can take place either at room temperature or using a forced-air dryer depending upon the specific water-based ink used and the speed or volume of production. While water-based inks are defined as those that utilize water as the main solvent, they can contain co-solvents which are petroleum based. Many water-based inks can also be more quickly cured with the addition of a catalyst. The disadvantage of a catalyst is that once it is added to a water-based ink, it creates a time limit or pot life where the ink must be all used in a certain time or be discarded.

Plastisol inks contain poly(vinyl chloride) and little or no solvent. Along with UV inks used in graphic screen printing, it is referred to as a 100% solid ink system. Plastisol inks are cured by exposure to temperatures in the range of about 320° F. to about 350° F. for a period of five to ten minutes or more which causes PVC to crosslink and solidify. In the ranges below 320° F. and above 350° F., the plastisol will not properly set, resulting in cracking, or it may become liquefied. Moreover, if a dye in the textile is overheated, it will migrate, or the textile or substrate may scorch or burn, increasing waste and production costs. Plastisol inks are available in various opacities with the most opaque being the most expensive, mainly due to the cost of the increased pigment.

Water based inks containing acrylics are also commonly used in screen printing and must be cured by exposure to heat for a period of time. Discharge inks are water-based inks for screen printing. The inks are mixed with an activator such as formaldehyde and a pigment and are used with cotton containing textiles and no base coat is required. Discharge inks are cured by heating to 320° F. for a sufficient period of time to evaporate the water and to discharge the ink into the fibers of the textile.

Sublimation inks are water based inks for direct to garment printing using a digital printer and have to be heated to cure the ink to about 320° F.

Decorative foil application to textiles and other substrates allow for the application of a foil from a carrier film. The film has a substrate layer and a transfer layer. A textile is prepared for foil application by applying an adhesive or an ink through a screen into the desired location and pattern. The prepared textile is indexed into the foil application station where a portion of the transfer layer is adhered to the ink/adhesive and the used film is peeled away leaving behind the foil. One prior art machines for foil application to a substrate is disclosed in U.S. Pat. No. 5,970,874. The '874 patent utilizes a heated platen mounted for reciprocating movement toward a support also mounted for reciprocating movement and a supporting pallet is positioned therebetween. A substrate is placed on the pallet and the platen and the support are moved into cooperative engagement to apply heat and pressure to the substrate. This machine is heavy and requires a supporting structure that engages a floor independent of the printing press.

International Publication No. WO 2008/020777 discloses a press with a pressing roll for transferring a motif from a carrier foil onto an underlying garment. The press is mounted to an existing printing machine in place of a standard screen printing head. The press has a generally rectangular frame for mounting to an arm of the screen printing machine defining a printing area. An inflatable cloth is placed in the printing area and lies between the pressing roll and the substrate to be decorated. A set of feeder rollers are mounted on one lateral edge of the frame and a set of take-up rollers are mounted on an opposed lateral edge of the frame. Foil is drawn by the take-up rollers from the feeder rollers through the printing area and under the inflatable cloth and in contact with the substrate to be decorated. The thermal cloth is inflated to stretch the foil to eliminate any wrinkles and the pressing roll is activated to pass between end edges of the frame in a direction orthogonal to the printing press support arm. Heat is applied by the inflatable cloth or the pressing roll and pressure to adhere the motif to the substrate. After the motif has been transferred, the inflatable cloth is deflated and the take-up rollers rotate to give the foil some slack. Compressed air is then provided to form an air pocket between the substrate and the film to separate the foil from the motif and substrate. Upon separation, the take-up rollers are then rotated in the opposite direction to draw the used foil onto the rolls for later disposal or recycling and to pull unused foil from the feeder rollers into the printing area for the next application.

### SUMMARY OF THE INVENTION

The present invention provides a foil applicator assembly for a screen printing press having a support arm extending along a first line. The assembly has a carriage having a leading edge and a trailing edge and is mounted for reciprocating translational motion along the first line. A press roller is mounted to the carriage and has a first axis of rotation generally orthogonal to the first line. A film supply roller is mounted proximate the printing press by a member that is stationary with respect to the carriage and provides a second axis of rotation parallel to the first axis of rotation and has a first outer surface. A film guide member is attached to the carriage and is spaced from the press roller along the first line.

The present invention further provides a method of applying foil onto a textile on an object support of a printing press. The method includes the steps of: (1) providing a carriage having a leading edge and a trailing edge and mounted for reciprocating translational motion along a first line between a first location and a second location; (2) providing a press roller mounted to the carriage and having a first axis of rotation generally orthogonal to the first line; (3) moving the carriage by a first motor along the first line from the first location to the second location and pulling a length of film from a film supply roller, the film having a transfer layer on a substrate layer; (4) pressing a portion of the film into contact with a textile on the object support to adhere a portion of the transfer layer to the textile and creating a length of used film; and (5) winding a portion of the length of the used film about a take-up roller. The method further includes providing a film guide member mounted on the carriage and spaced along the first line from the press roller. The press roller can be positioned on the leading edge or the trailing edge of the carriage and the film guide member can be positioned in the opposite location.

The step of moving the carriage along the first line from the first location to the second location further includes the step of peeling a portion of the used film from the textile. The step of winding a portion of the length of the used film about a take-up roller is done in response to moving the carriage from the second location to the first location.

Alternatively, the engaging member peels the used film from the textile when the carriage is moved from the second location to the first location. The method also includes the step of providing a second motor for rotating the take-up roller and the step of winding the used film includes moving the carriage a second time from the first location to the second location with the first motor while rotating the take-up roller with the second motor.

### BRIEF DESCRIPTION OF THE DRAWINGS

To understand the present invention, it will now be described by way of example, with reference to the accompanying drawings and attachments in which:

FIG. 1 is perspective view of a prior art screen printing press manufactured and sold by the M&R Companies, the assignee of the present invention, under the tradename SPORTSMAN® EX.

FIG. 2 is perspective view of a prior art screen printing press manufactured and sold by the M&R Companies, the assignee of the present invention, under the tradename STRYKER™.

FIG. 3A is a side elevation view of an in head foil applicator of the present invention in a start or a first location.

FIG. 3B is a side elevation view of an in head foil applicator of the present invention in a finish or a second location.

FIG. 4A is a side elevation view of an alternate embodiment of an in head foil applicator of the present invention in a start position.

FIG. 4B is a side elevation view of an alternate embodiment of an in head foil applicator of the present invention in an intermediate position.

FIG. 4C is a side elevation view of an alternate embodiment of an in head foil applicator of the present invention in a finish position.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

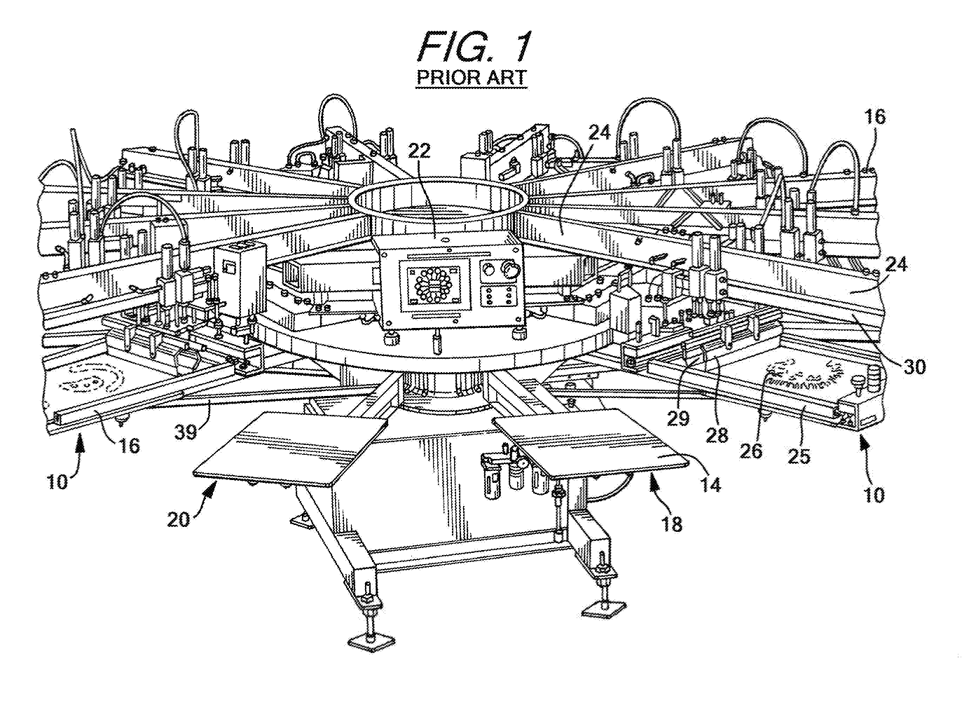

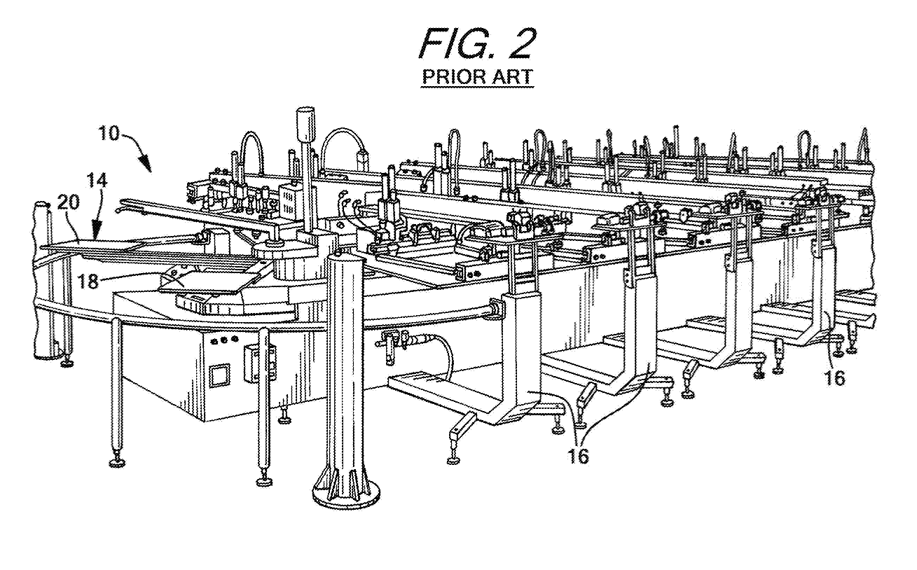

FIGS. 1 and 2 show prior art screen printing machines 10, one having a circular track 12 or rail (FIG. 1), and the other having an oval track 12 or rail (FIG. 2). An endless conveyor is mounted for movement about an axis of rotation of the track in a clockwise or counterclockwise direction. A plurality of object supports 14 are attached to and extend radially away from the conveyor and move therewith through a common horizontal plane (i.e., the same distance above the surface supporting the press). Textiles are loaded on to the object supports and are moved with the conveyor from station 16 to station 16 in an indexed fashion and pause at each station for a sufficient period of time for a printing operation, or other operation, to be performed. The conveyor is moved by a motive source such as an electric motor and the movement is controlled by an indexer control mechanism to set the speed of rotation and the period at rest at each station. There are a variety of station types including a screen printing station 16, an ink drying or curing station, a loading station 18, an unloading station 20 and other stations to serve other purposes that are well known to those of ordinary skill in the art. The present invention provides a foil applicator assembly or system 100, 200 discussed below as a station of a printing press.

A screen printing station has a head assembly having an arm 24 pivotally connected on a frame 22 to overlie a pallet 14 and is mounted for movement between a printing position and a non-printing position. The printing head 24 includes a screen frame 25 for supporting a printing screen 26 that has a desired pattern for printing a white base coat or other desired color. Each station prints a single color. A squeegee 28 and a flood bar 29 are movably mounted to a squeegee bar 30 mounted to the arm 24 for traversing a printing stroke when the head assembly is disposed in the printing position and a flood stroke when the head assembly is in the non-printing position. The printing stroke requires moving the squeegee 28 and the flood bar 29 from a first position to a second position, and the flood stroke requires moving the squeegee and the flood bar from the second position to the first position. The movement of the squeegee and flood bar horizontally uses a motive source such as an electric motor and vertically in the figures is accomplished using a pneumatic control and is well known to those of skill in the art or manually by an operator of the press. As will be discussed below, these controls can also be used to control the movement of the foil applicator of the present invention.

Operatively connected to the frame of the head assembly are one or more locating bars 39 which are cooperatively associated with the object supports to ensure proper registration of the object supports when the printing head assembly is disposed in the printing position. The 20508 conveyor is driven on its endless path by a drive mechanism such as a chain or belt which is threaded about a sprocket journaled on a main drive shaft which is coupled in driving relationship to a drive motor. Operatively associated with the drive mechanism is an indexing system to effect an intermittent indexing of the respective object supports from station to station during machine operation.

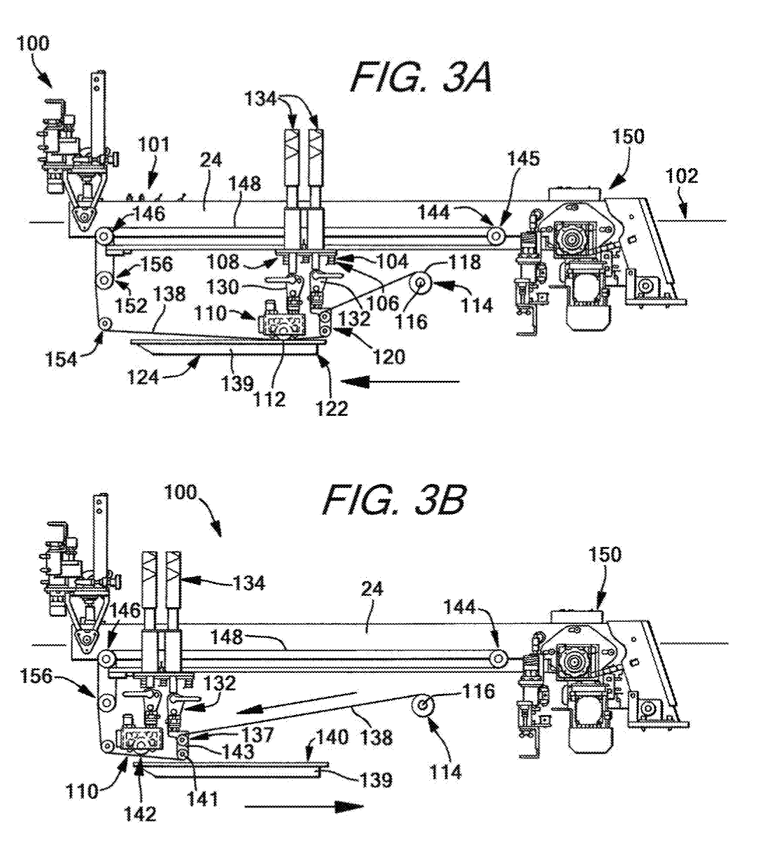

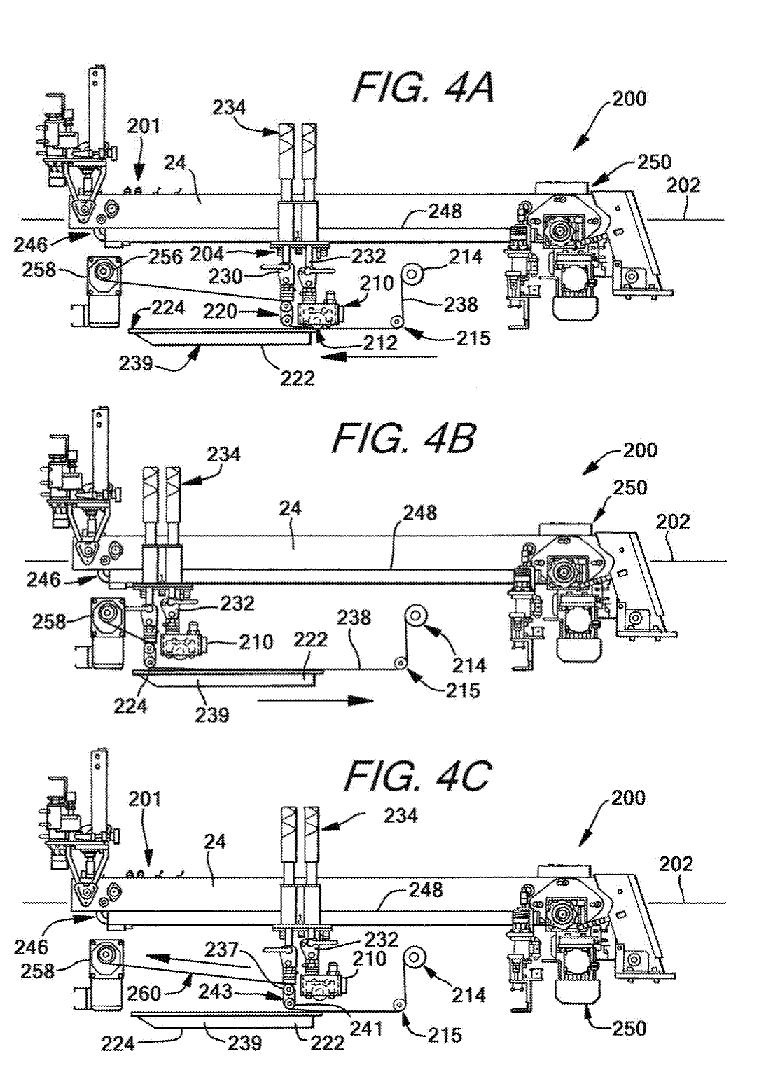

FIGS. 3A, B show a foil applicator assembly and system 100 of the present invention having controls 101 for controlling the horizontal and vertical operation of the squeegee bar and flood bar. A printing press support arm 24 extends along a first line 102 and has a carriage 104 having a leading edge 108 and a trailing edge 106 mounted thereto for reciprocating translational motion along the first line 102. A press roller 110 is mounted to the carriage 104 and has a first axis of rotation 112 generally orthogonal to the first line 102, in this view extending into the plane of the paper. A film supply roller 114 is mounted proximate the press by a member that is stationary with respect to the carriage 104 and provides a second axis of rotation 116 parallel to the first axis of rotation 112 and has a first outer surface 118. While a single film supply roller 114 is shown, it is contemplated that two or more could be provided and used at the same time. In a preferred aspect, an electromagnetic clutch is provided to allow rotation about the first axis in a single direction, in this case counterclockwise, and only when the carriage is moving from the first location 122 to the second location 124. A film guide member 120 is attached the carriage 104 spaced from the press roller 110 along the first line 102. The press roller 110 is positioned proximate the leading edge 108 and the film guide member 120 is positioned proximate the trailing edge 106 of the carriage in the embodiment shown in FIGS. 3A,3B, and in the opposite orientation in the embodiment shown in FIGS. 4A, B, C.

The press roller 110 is mounted to a squeegee mounting bar 130 and the film guide member 120 is mounted to a flood mounting bar 132. The squeegee mounting bar 130 and the flood bar132 are moved along a second line orthogonal to the first line, or in a vertical direction as shown, using pneumatic regulators 134 between engaged and disengaged positions. FIG. 3A shows the press roller 110 and the guide member 120 in the engaged position. FIG. 3B shows the press roller 110 in the disengaged position and the guide member 120 in the engaged position. When in the engaged position, the press roller 110 presses against a film 138 directly against a textile mounted on an object support such as a pallet 139 or against an interposed layer of Kraft paper or a PTFE sheet to resist sticking of the roller to the film. However, one of the advantages of the present invention is to render the interposed layer unnecessary. This speeds the process and reduces the costs.

The guide member 120 has a pair of rollers 136 in vertical spaced relationship and each has an axis of rotation parallel to the second axis or rotation 116. A top roller 137 has a surface tangentially aligned with the surface 118 of the film supply roller 114. A bottom roller 141 is vertically spaced providing a nip 143 between the rollers of sufficient dimension to allow the film 138 to pass through the nip and has a lower peripheral surface that is in close proximity or in contact with the textile on the palette 139. The film forms an S-shaped pattern winding counterclockwise over the top surface of the top roller 137, along the outer peripheral surface, through the nip 143, then switching back in a clockwise direction along the outer peripheral surface of the lower roller 141. A bottom peripheral surface is in close proximity or in contact with the textile and peels the substrate layer away from the textile immediately after a portion of the transfer layer has been adhered to a prepared textile during a first trip of the carriage 104 from a first location 122 to a second location 124 by application of heat and pressure by the press roller 110.

The carriage 104 is moved back and forth along the first line 102, or horizontally as shown, from the first position 122 to the second position 124 by a drive assembly 145. The drive assembly 145 has a drive roller 144, a driven roller 146 and a timing belt 148 trained about these rollers and that turns the driven roller 146 when the drive roller 144 is rotated by a motive source such as an electric motor 150. Limit switches at both the first and second positions 122,124 can be employed to ensure the carriage 104 travels the desired length of travel. A series of take-up rollers 152 are provided including a guide roller 154 and a used foil roller 156. Like the film supply roller 114, in a preferred form, the take-up rollers 152 are controlled for movement by an electromagnetic clutch to allow rotation in a single direction, in this case clockwise as shown, and only when the carriage 104 is moving from the second position 124 to the first position 122.

One suitable film is a heat transfer metallic foil supplied in rolls having a desired set of dimensions such as, for example, 12″ wide by 200′ long. The film has a multilayer structure with a backing layer and a transfer layer. The transfer layer has the desired color and finish to be applied to the textile. An adhesive or an ink is applied to the textile through a prepared screen having the desired pattern at a first screen printing station as is well known in the art. The adhesive can be cured using UV light or heat, if necessary, at a station to form a prepared textile. Then the prepared textile is moved to the foil application station where a portion of the transfer layer is adhered to the textile exclusively in the location of the adhesive or ink and the substrate layer is peeled away and taken up by the take-up rollers and collected on the used foil roller 156 for disposal.

FIGS. 4A, B, C show a foil applicator assembly and system 200 of the present invention that differs in a few respects from the one just described. Common elements will be referred with the same number but in a 200 series of numbers. First, the film guide member 220 is positioned on the leading edge 208 of the carriage 204 and the press roll 210 is positioned on the trailing edge 206. Also, the film 238 is wound first about the bottom roller 241 in a clockwise direction, then through the nip 243, and then counterclockwise direction over the top roller 237 and a top surface of the top roller 237 is tangentially aligned with the take-up roller 256. Second, the take-up roller 256 is rotated by a second motor 258 and provides the motive force for pulling the film during the foil application process. Third, the film supply roller 214 is not tangentially aligned with the alignment member, rather there is an interposed idler roller 215 which has a lower outer peripheral edge in alignment with a surface of the palette 239.

The present invention further provides a method of applying foil onto a textile on an object support of a printing press. The method includes the steps of: (1) providing a carriage having a leading edge and a trailing edge and mounted for reciprocating translational motion along a first line between a first location and a second location; (2) providing a press roller mounted to the carriage and having a first axis of rotation generally orthogonal to the first line; (3) moving the carriage by a first motor along the first line from the first location to the second location and pulling a length of film from a film supply roller, the film having a transfer layer on a substrate layer; (4) pressing a portion of the film into contact with a textile on the object support to adhere a portion of the transfer layer to the textile and creating a length of used film; and (5) winding a portion of the length of the used film about a take-up roller. The method further includes providing a film guide member mounted on the carriage and spaced along the first line from the press roller. The press roller can be positioned on the leading edge or the trailing edge of the carriage and the film guide member can be positioned in the opposite location.

The step of moving the carriage along the first line from the first location to the second location further includes the step of peeling a portion of the used film from the textile. The step of winding a portion of the length of the used film about a take-up roller is done in response to moving the carriage from the second location to the first location.

Alternatively, the engaging member peels the used film from the textile when the carriage is moved from the second location to the first location. The method also includes the step of providing a second motor 258 for rotating the take-up roller 256 and the step of winding the used film includes moving the carriage 204 a second time from the first location 222 to the second location 224 with the first motor 250 while rotating the take-up roller 256 with the second motor 258.

More specifically, to prepare for operation the foil applicator assembly and system 100 shown and described with respect to FIGS. 3A, B, a fresh roll of foil is mounted on the film supply roller 114 and a leading edge is pulled from the roll and threaded over the top of the top roller 137 of the film alignment member 120 counterclockwise then through the nip 143 and then counterclockwise over the bottom surface of the bottom roller 141. The leading edge is then pulled across the palette 138 and about the take-up rollers 152.

A foil application process is carried out by first preparing a screen with the desired pattern and applying an ink, adhesive or other material for adhering foil from the transfer layer to the textile to form a prepared textile. The prepared textile is then indexed into the print station with the foil application assembly 100 and using the existing squeegee and flood bar controls 101, the carriage 104 is moved from the first position 122 to the second position 124 with both the press roller 110 and the film guide member 120 in the engaged position. The press roller 110 applies heat and pressure to the textile pressing the transfer layer against the adhesive or ink to transfer a portion of the transfer layer to the textile only in the area where the adhesive/ink is located. The film guide member 120 trailing behind the press roller 110 peels the substrate layer away from the textile leaving behind the foil on the textile. Additionally, the film supply roller 114 is allowed to rotate and feed out film for the next foil application process but the take-up roller 156 is not allowed to rotate. When the carriage 104 has reached the second location 124 the foil application is complete and the entire length of used film has been separated from the textile. Now the carriage 104 is moved from the second position 124 to the first position 122 with the film guide 120 in the engaged position and the press roller 110 in the disengaged position. The take-up roller 156 is allowed to rotate and spool the used film on the take up rollers and the film supply roller 114 is not allowed to rotate. The palette 139 with the foiled textile is indexed to the next station and the next palette 139 is indexed into the foil application station during the return trip or after the return trip when the carriage reaches the first position. Then the process is repeated.

Now to describe the preparation and operation of the second foil application assembly 200 shown in FIGS. 4A-4C. While the first embodiment is a two-step process, the second embodiment uses a three-step process with two complete passages of the carriage 204 between the first and second positions 222, 224. To set up the foil application assembly 200, a leading edge of the film 238 is drawn from the film supply roller 214, then about the guide roller 215 then over the palette 239 and under the press roller 210. Then the leading edge is wound through the rollers 237, 241 of the film guide member 220, first under the bottom roller 241 in a clockwise direction, then through the nip 243, then clockwise over the top roller 237 then above the palette up to the used foil roller 256.

A prepared textile is indexed into the foil application station 200 and using the existing squeegee and flood bar controls 201, the carriage 204 is moved from the first position 222 toward the second position 224 with both the press roller 210 and the film guide member 220 in the engaged position. Both the film supply roller 214 and the take-up roller 256 are not allowed to rotate. The length of film that was above the palette 239 gets pressed against the textile by the press roller 210 thereby pulling the length of film through the rollers 237,241 and into engagement with the textile. When the carriage 204 reaches the second position 224, the length of film from the take-up roller to the leading edge of the palette is used film 260 (FIG. 4C). Now the press roller 210 is moved into the disengaged positon with the film guide member 220 in the engaged position and during the return trip from the second position to the first position, both the film supply roller 214 and the take-up rollers 256 do not rotate. During this return trip, the substrate layer is peeled away from the textile leaving behind the transferred foil on the textile in the desired location. Now in a third leg of the operation in a second pass from the first position 222 to the second position 224, both the film supply roller 214 and the take-up roller 256 are allowed to rotate, in opposite directions, to spool the used foil 260 about the take up roller 252 and to pull fresh foil from the supply roller 214. Then on the fourth leg of the operation from the second position 224 to the first position 222, both the supply roller 214 and the take-up roller 256 are not allowed to rotate. When the carriage 204 reaches the first position 222 a second time the station is ready for another printing operation and a new prepared textile is indexed into position and the process is repeated.

Many modifications and variations of the present invention are possible in light of the above teachings. It is, therefore, to be understood within the scope of the appended claims the invention may be protected otherwise than as specifically described.

1. A foil applicator assembly for a screen printing press having a support arm extending along a first line comprising:
a carriage having a leading edge and a trailing edge and mounted for reciprocating translational motion along the first line;
a press roller mounted to the carriage and having a first axis of rotation generally orthogonal to the first line;
a film supply roller mounted proximate the press by a member that is stationary with respect to the carriage and provides a second axis of rotation parallel to the first axis of rotation and has a first outer surface; and
a film guide member on the carriage spaced from the press roller along the first line.

2. The foil applicator assembly of claim 1 wherein the carriage is mounted to a portion of the support arm.

3. The foil applicator assembly of claim 1 further comprising a heater connected to the press roller to heat an outer surface of the press roller.

4. The foil applicator assembly of claim 1 wherein the film guide member has a second outer surface tangentially aligned with the first surface.

5. The foil applicator assembly of claim 4 wherein the film guide member comprises a first tensioning roller having a third axis of rotation and supporting the second surface.

6. The foil applicator assembly of claim 1 further comprising:
a take-up roller mounted proximate the printing press by a member that is stationary with respect to the carriage and having a fourth axis of rotation parallel to the first axis of rotation.

7. The foil applicator of claim 1 further comprising a first member for moving the carriage back and forth between a first position and a second position.

8. The foil applicator assembly of claim 7 wherein the first member comprises a drive roller, a driven roller spaced along the first line from the drive roller, a belt connecting the drive roller to the driven roller, and a motive source connected to the drive roller, the belt being connected to the carriage.

9. The foil applicator assembly of claim 8 further comprising a second member for moving the press roller along a second line orthogonal to the first line between an engaged position and a disengaged position.

10. The foil applicator assembly of claim 9 further comprising a controller connected to the first member and the second member for controlling the movement of the carriage.

11. The foil applicator assembly of claim 9 wherein the second member is pneumatically operated or hydraulically operated.

12. The foil applicator assembly of claim 10 further comprising a first limit switch at the first location and a second limit switch at the second location, the first limit switch and the second limit switch being electrically connected to the controller.

13. The foil applicator assembly of claim 6 wherein the take-up roller rotates in response to the carriage moving from the second position to the first position, and a first electromagnetic clutch prevents the take-up roller from rotating when the carriage moves from the first position to the second position.

14. The foil applicator assembly of claim 13 wherein the take-up roller is connected by a belt to the driven roller.

15. The foil applicator assembly of claim 6 wherein the supply roller rotates about the second axis in response to the carriage moving from the first position to the second position, and a second electromagnetic clutch prevents the supply roller from rotating when the carriage moves from the second position to the first position.

16. The foil applicator assembly of claim 9 wherein the press roller is in the engaged position when the carriage moves from the first position to the second position and is in the disengaged position when the carriage moves from the second position to the first position.

17. The foil applicator assembly of claim 1 wherein the press roller is mounted proximate the leading edge and the film attachment member is mounted proximate the trailing edge.

18. The foil applicator assembly of claim 1 wherein the press roller is mounted proximate the trailing edge and the film attachment member is mounted proximate the leading edge.

19. The foil applicator assembly of claim 18 wherein the take up roller is rotated by a motor.

20. The foil applicator assembly of claim 19 further comprising an idler roller spaced from the film supply roller and an object support connected to the press and radially extending away therefrom and having a planar surface, the idler roller having a curved surface tangentially aligned with both the first outer surface and the planar surface.

21-28. (canceled)
